(19) United States
(12) Patent Application Publication
(10) Pub. No.: US 2023/0328371 A1
(43) Pub. Date: Oct. 12, 2023

(54) WEARABLE TERMINAL

(71) Applicant: JOHNAN Corporation, Kyoto (JP)

(72) Inventors: Kozo MORIYAMA, Kyoto (JP); Shin KAMEYAMA, Kyoto (JP); Truong Gia VU, Kyoto (JP); Lucas BROOKS, Kyoto (JP)

(21) Appl. No.: 18/188,317

(22) Filed: Mar. 22, 2023

(30) Foreign Application Priority Data
Mar. 29, 2022 (JP) 2022-052961

(51) Int. Cl. H04N 23/667; H04N 7/18

(52) U.S. Cl. CPC H04N 23/667; H04N 7/183; H04N 5/2628

(57) ABSTRACT

Provided herein is a wearable terminal that includes a camera, a wireless communication antenna, a memory and a processor for changing the capture mode of the camera or communication mode of the wireless communication antenna when a predetermined condition is satisfied.

### BACKGROUND OF THE INVENTION

### Field of the Invention

The present invention relates to a technology of a wearable terminal having a camera.

### Description of the Related Art

A wearable terminal having a camera is known. For example, Japanese Patent Laying-Open No. 2012-205163 discloses a wearable camera. It comprises a camera section having an imaging lens and an imaging element. A camera processing unit has a control unit connected to the camera unit and an alarm output unit connected to the control unit. The control unit transmits a dirt detection output to the alarm output unit when dirt is detected on the front part of the imaging lens.

### SUMMARY OF INVENTION

An object of the present invention is to provide a technique for efficiently capturing images and communicating while suppressing power consumption of a wearable terminal.

According to a certain aspect of the present invention, there is provided a wearable terminal that includes a camera, a wireless communication antenna, a memory and a processor for changing the capture mode of the camera or communication mode of the wireless communication antenna when a predetermined condition is satisfied.

The present invention has enabled efficiently capturing images and communicating while suppressing power consumption of a wearable terminal.

### BRIEF DESCRIPTION OF THE DRAWINGS

FIG. 1 is an image diagram showing the overall configuration of a network system according to the first embodiment.

FIG. 2 is a block diagram of the configuration of the control device according to the first embodiment.

FIG. 3 is a block diagram of a configuration of the wearable terminal according to the first embodiment.

FIG. 4 is a block diagram showing the configuration of the robot according to the first embodiment.

FIG. 5 is a flow chart showing mode change process according to the first embodiment.

FIG. 6 is a flow chart showing mode change process according to the second embodiment.

FIG. 7 is a flow chart showing mode change process according to the third embodiment.

### DESCRIPTION OF THE PREFERRED EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

### First Embodiment

### Overall Configuration and Overview of Operation of Network System 1

An overall configuration and operation overview of a network system 1 according to an embodiment of the invention is described below, with reference to FIG. 1. Network system 1 according to the present embodiment includes, mainly, a control device 100 and a wearable terminal 300. The network system 1 may include a robot 600 or the like that supports the worker.

The control device 100 performs data communication with the wearable terminal 300 and the robot 600 via a wired LAN, wireless LAN, or mobile communication network.

The robot 600 performs various tasks based on commands from the control device 100 or according to its own judgment.

The wearable terminal 300 can be worn on the head of a worker or a user like glasses. The wearable terminal 300 has a camera and transmits captured still images and captured moving images to control device 100. In the present embodiment, wearable terminal 300 normally executes the power saving mode, that is the normal mode. The wearable terminal 300 reduces the frequency of capturing images, reduces the amount of captured image data, stops uploading image data to the control device 100, reduces the frequency of uploading image data to the control device 100, and/or reduces the amount of uploads image data, as the power saving mode. Conversely, when a predetermined condition is satisfied, wearable terminal 300 executes the check mode. The wearable terminal 300 increases the frequency of capturing images, increases the amount of captured image data, starts uploading image data to the control device 100, increases the frequency of uploading image data to the control device 100, and/or increase the amount of uploads image data as the check mode.

As described above, in this embodiment, the wearable terminal 300 can store accurate information and provide accurate information to the control device 100 in important situations while suppressing power consumption. The configuration and operation of each part of the network system 1 will be described in detail below.

### Configuration of Control Device 100

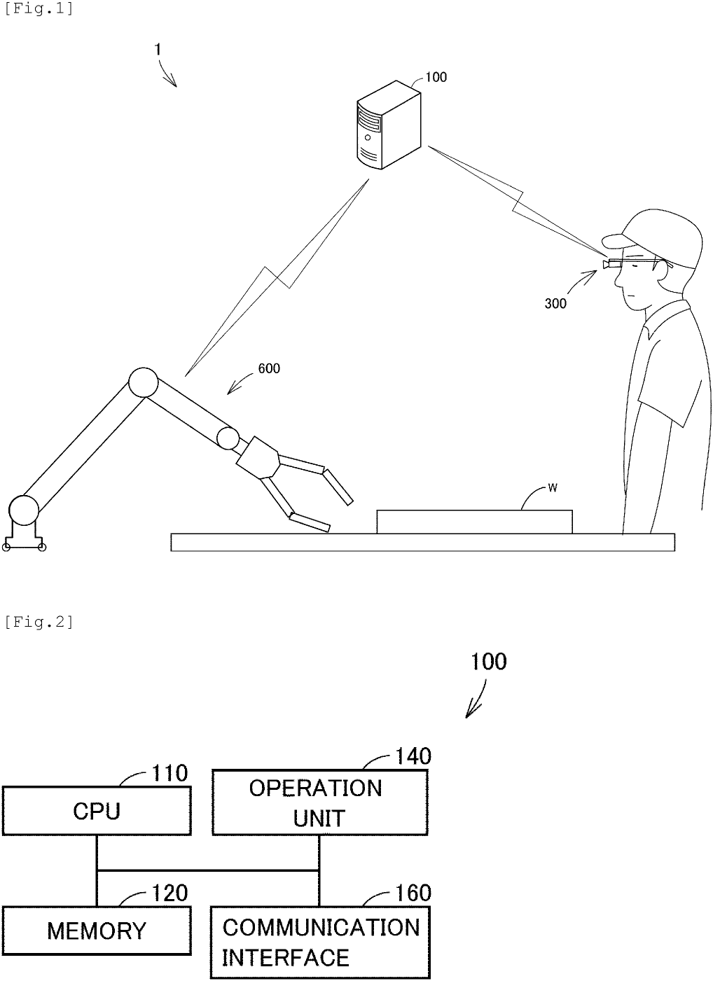

One aspect of the configuration of the control device 100 included in the network system 1 according to the present embodiment will be described. Referring to FIG. 2, control device 100 includes CPU (Central Processing Unit) 110, memory 120, operation unit 140, and communication interface 160 as main components.

CPU 110 controls each part of control device 100 by executing a program stored in memory 120. For example, CPU 110 executes a program stored in memory 120 and refers to various data to perform various processes described later.

Memory 120 is realized by, for example, various types of RAMs (Random Access Memory) and ROMs (Read-Only Memory). The memory 120 may be included in the control device 100. The memory 120 may be detachable from various interfaces of the control device 100. The memory 120 may be realized by a recording medium of another device accessible from the control device 100. The memory 120 stores programs executed by the CPU 110, data generated by the execution of the programs by the CPU 110, data input from various interfaces, other databases used in this embodiment, and the like.

Operation unit 140 receives commands from users and administrators and inputs the commands to the CPU 110.

Communication interface 160 transmits data from CPU 110 to robot 600 and wearable terminal 300 via a wired LAN, wireless LAN, mobile communication network, or the like. Alternatively, communication interface 160 receives data from robot 600 and wearable terminal 300 and transfers the data to CPU 110.

### Configuration of Wearable Terminal 300

Next, one aspect of the configuration of the wearable terminal 300 included in the network system 1 will be described. Wearable terminal 300 according to the present embodiment may have the form of glasses, or may be a communication terminal with a camera that can be attached to a hat or clothes. Since the wearable terminal 300 according to the present embodiment is driven by battery power, a power saving mechanism is important as described later.

Referring to FIG. 3, wearable terminal 300 according to the present embodiment includes, as main components, CPU 310, memory 320, display 330, operation unit 340, camera 350, communication antenna 360, speaker 370, microphone 380, acceleration sensor 390, position acquisition antenna 395, battery 399 and the like. The camera 350 of this embodiment is a three-dimensional depth camera. Camera 350 may be a conventional two-dimensional camera.

CPU 310 controls each unit of wearable terminal 300 by executing programs stored in memory 320.

Memory 320 is realized by, for example, various types of RAMs and ROMs. Memory 320 stores various application programs, data generated by execution of programs by CPU 310, data received from control device 100, data input via operation unit 340, image data captured by camera 350, current position data, current acceleration data, current posture data and the like.

Display 330 is held, by various structures, in front of the right eye and/or left eye of the user who is wearing the wearable terminal 300. Display 330 displays images and text based on data from CPU 310.

Operation unit 340 includes buttons, switches, and the like. The operation unit 340 inputs various commands input by the user to the CPU 310.

Camera 350 captures still images and moving images based on instructions from CPU 310 and stores image data in memory 320.

Communication antenna 360 transmits and receives data to and from other devices such as control device 100 via a wired LAN, wireless LAN, mobile communication network, or the like. For example, communication antenna 360 receives a capture command from control device 100 and transmits the captured image data in memory 320 to control device 100 according to an instruction from CPU 310.

Speaker 370 outputs various sounds based on signals from CPU 310. CPU 310 may audibly output various voice messages received from control device 100. The CPU 310 also causes the display 330 to output the various information.

Microphone 380 receives voice and inputs voice data to CPU 310. The CPU 310 may receive a user’s voice message, such as various information and various commands, and pass the voice message data to the control device 100. The CPU 310 also receives information and instructions from the operation unit 340.

Acceleration sensor 390 is, for example, a 6-axis acceleration sensor. The acceleration sensor 390 measures the acceleration and rotation of the wearable terminal 300 and inputs them to the CPU 310. Thereby, the CPU 310 can calculate the posture of the wearable terminal 300.

Position acquisition antenna 395 receives beacons and signals from the outside and inputs them to the CPU 310. Thereby, the CPU 310 can calculate the current position of the wearable terminal 300.

Battery 399 stores power and provides the power to each unit of wearable terminal 300.

In the present embodiment, as the power saving mode, CPU 310 changes the capture mode of camera 350 so as to reduce power consumption. For example, the CPU 310 lowers the resolution of the camera 350, lowers the capture frequency, lowers the frame rate, and/or switches to the two-dimensional capture mode. Conversely, as the check mode, the CPU 310 changes the capture mode of the camera 350 so that accurate information can be obtained from the captureded image. For example, the CPU 310 increases the resolution of the camera 350, increases the capture frequency, increases the frame rate and/or switch to 3D capture mode.

Further, in the present embodiment, as the power saving mode, CPU 310 changes the communication mode of wireless communication antenna 360 so that power consumption by communication is reduced. For example, CPU 310 stops communication with control device 100, reduces the frequency of communication with control device 100, lowers the resolution of images to be transmitted to control device 100, and/or reduces the frame rate of moving images to be transmitted to control device 100. Conversely, as check mode, the CPU 310 changes various settings so as to provide accurate information to the control device 100. For example, CPU 310 starts communication with control device 100, increases the frequency of communication with control device 100, increases the resolution of images to be transmitted to control device 100, and/or increases the frame rate of moving images to be transmitted to control device 100.

### Configuration of Robot 600

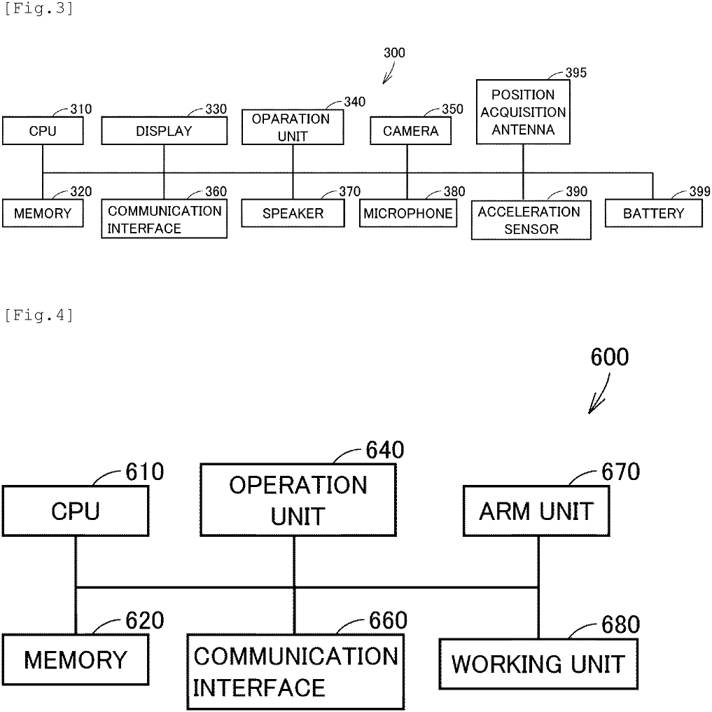

Next, one aspect of the configuration of the robot 600 included in the network system 1 will be described. Referring to FIG. 4, robot 600 according to the present embodiment includes, as main components, CPU 610, memory 620, operation unit 640, communication interface 660, arm unit 670, working unit 680, and the like.

CPU 610 controls each part of the robot 600 by executing various programs stored in the memory 620.

Memory 620 is implemented by various RAMs, various ROMs, and the like. Memory 620 stores various application programs, data generated by execution of programs by CPU 610, operation commands given from control device 100, data input via various interfaces, and the like.

Operation unit 640 includes buttons, switches, and the like. The operation unit 640 transfers various commands input by the user to the CPU 610.

Communication interface 660 transmits and receives data to and from other devices such as control device 100 via a wired LAN, wireless LAN, mobile communication network, or the like. For example, communication interface 660 receives an operation command from control device 100 and passes it to CPU 610.

Arm unit 670 controls the position and orientation of working unit 680 according to instructions from CPU 610.

Working unit 680 performs various operations, such as grasping, releasing an object and using tools, according to instructions from CPU 610.

### Information Processing of Wearable Terminal 300

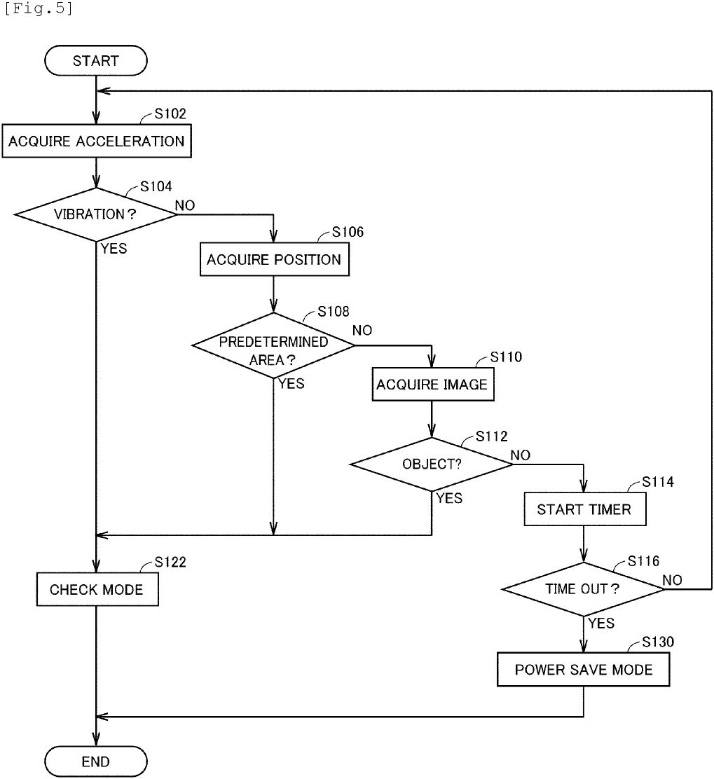

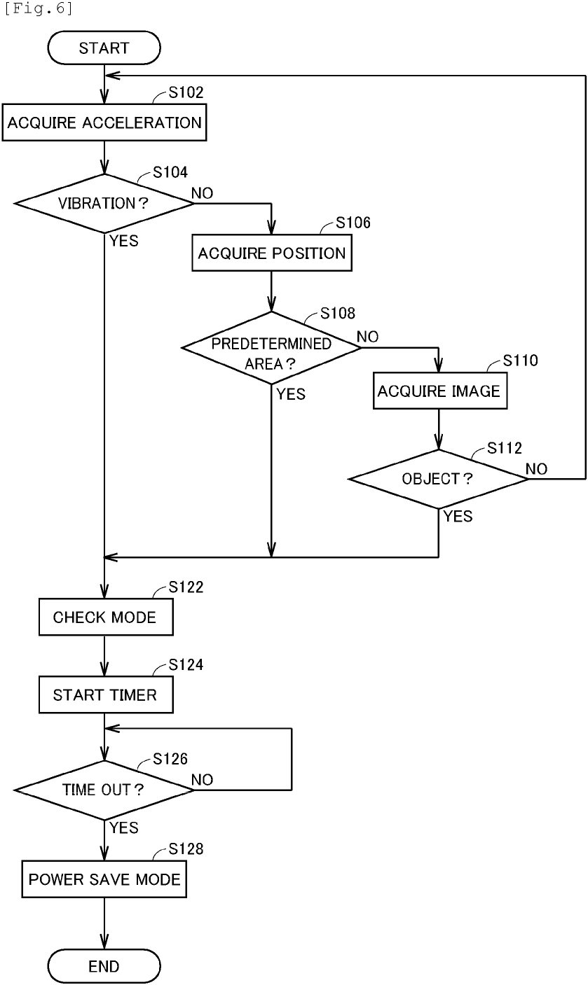

Next, referring to FIG. 5, information processing of wearable terminal 300 in the present embodiment will be described in detail. CPU 310 of wearable terminal 300 executes the processing shown in FIG. 5 according to the program in memory 320.

In the present embodiment, CPU 310 periodically exchanges data with control device 100 via communication interface 360 and execute the following processes.

The CPU 310 acquires the acceleration value measured by the acceleration sensor 390 (step S102). The CPU 310 determines whether or not vibration of a predetermined level or more has been detected (step S104). When vibration of a predetermined level or more is detected (YES in step S104), CPU 310 shifts to check mode or maintains the check mode (step S122). More specifically, the CPU 310 sets a higher resolution of image data captured by camera 350, sets a higher frame rate for image data captured by the camera 350, starts communication with the control device 100, and sets a higher frequency of communication with the control device 100.

When CPU 310 does not detect vibration (NO in step S104), CPU 310 acquires the current position of wearable terminal 300 based on the measurement value from position acquisition antenna 395 (step S106). CPU 310 determines whether the current position of wearable terminal 300 matches a predetermined position or is included in a predetermined area (step S108). When wearable terminal 300 reaches a predetermined position (YES in step S108), CPU 310 shifts to check mode or maintains the check mode (step S122). More specifically, the CPU 310 sets a higher resolution of image data captured by camera 350, sets a higher frame rate for image data captured by the camera 350, starts communication with the control device 100, and sets a higher frequency of communication with the control device 100.

When wearable terminal 300 has not reached the predetermined position (NO in step S108), CPU 310 acquires an image captured by camera 350 (step S110). CPU 310 determines whether or not a predetermined object is included in the captured image (step S112). CPU 310 may determine whether or not the worker, robot 600, workpiece, etc. are in a predetermined state (step S112). Note that the CPU 310 may capture an image with the camera 350 at this timing, or may read the latest captured image from the memory 320.

For example, in step S112, the CPU 310 may determine that the robot 600 is in the predetermined state, when the robot 600 is in the predetermined posture, when the robot 600 is performing a predetermined action, when the moving speed of the robot is higher than a predetermined speed, and/or when the distance between the robot 600 and the worker is within a predetermined distance. These conditions are set by the operator according to the state and/or type of work held by the robot.

When a predetermined object is included in the captured image, or when the CPU 310 recognizes a predetermined state (YES in step S112), CPU 310 shifts to check mode or maintains check mode. (Step S122). More specifically, the CPU 310 sets a higher resolution of image data captured by camera 350, sets a higher frame rate for image data captured by the camera 350, starts communication with the control device 100, and sets a higher frequency of communication with the control device 100.

When the captured image does not include the predetermined object, or when the CPU 310 does not recognize a predetermined state (NO in step S112), CPU 310 starts a timer or continues the timer counting (step S114). When the timer reaches the predetermined time without reaching the predetermined state (YES in step S116), CPU 310 shifts to power saving mode or maintains the power saving mode (step S130). More specifically, the CPU 310 sets a lower resolution of image data captured by camera 350, sets a lower frame rate for image data captured by the camera 350, stops communication with the control device 100, and sets a lower frequency of communication with the control device 100.

When the timer does not reach the predetermined time (NO in step S116), CPU 310 repeats the process from step S102.

### Second Embodiment

As shown in FIG. 6, after step S122, CPU 310 may reset and start the timer (step S124). CPU 310 may maintain the check mode until a predetermined time elapses (step S126). After a predetermined time, CPU 310 may stop the check mode and may shift to the power saving mode (step S128). CPU 310 periodically repeats the process from step S102.

### Third Embodiment

Other devices may perform part or all of the role of each device such as the control device 100, the wearable terminal 300, and the robot 600 of the network system 1 of the above embodiment. For example, control device 100 may play a part of the role of wearable terminal 300. A plurality of personal computers may play the role of the control device 100 or wearable terminal 300. Information processing of the control device 100 or wearable terminal 300 may be executed by a plurality of servers on the cloud.

For the example, the wearable terminal 300 may transmit the acceleration, current position, and captured image to the control device 100. CPU 110 of control device 100 may determine whether a predetermined condition is satisfied. CPU 110 may shift the wearable terminal 300 to check mode or power saving mode.

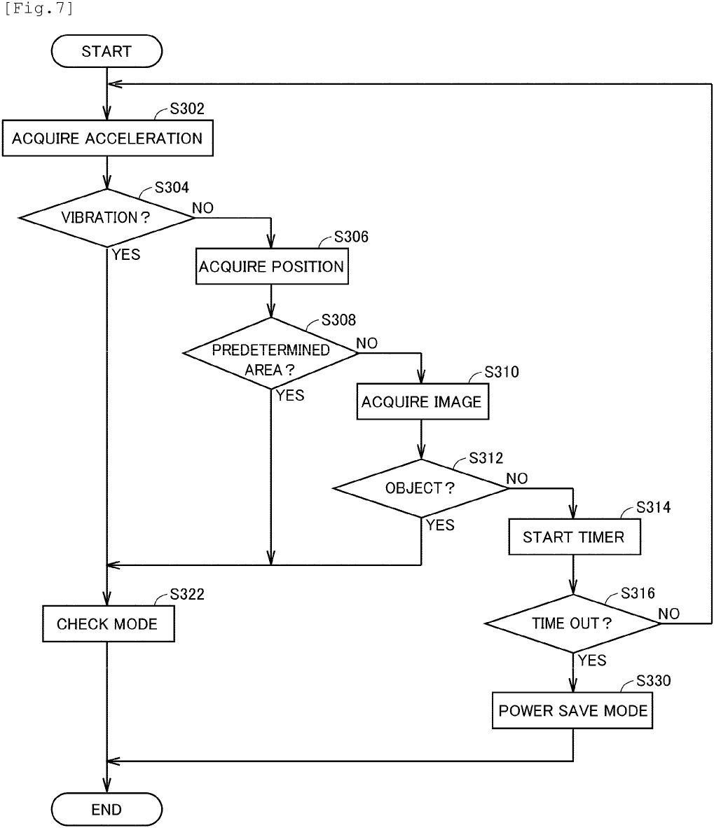

More specifically, referring to FIG. 7, CPU 110 of control device 100 acquires acceleration from wearable terminal 300 via communication interface 160 (step S302). CPU 110 determines whether vibration of a predetermined level or more is detected (step S304). When vibration of a predetermined level or more is detected (YES in step S304), CPU 110 transmits an instruction to shift to check mode to wearable terminal 300 via communication interface 160 (step S322). CPU 310 of wearable terminal 300 receives this command, sets a higher resolution of image data captured by camera 350, sets a higher frame rate for image data captured by the camera 350, starts communication with the control device 100, and sets a higher frequency of communication with the control device 100.

If vibration is not detected (NO in step S304), CPU 110 acquires the current position from wearable terminal 300 via communication interface 160 (step S306). CPU 110 determines whether the current position of wearable terminal 300 matches a predetermined position or is included in a predetermined area (step S308). When wearable terminal 300 reaches a predetermined position (YES in step S308), CPU 110 transmits an instruction to shift to check mode to wearable terminal 300 via communication interface 160 (step S322). CPU 310 of wearable terminal 300 receives this command, sets a higher resolution of image data captured by camera 350, sets a higher frame rate for image data captured by the camera 350, starts communication with the control device 100, and sets a higher frequency of communication with the control device 100.

When wearable terminal 300 has not reached the predetermined position (NO in step S308), CPU 110 acquires a captured image from wearable terminal 300 via communication interface 160 (step S310). CPU 110 determines whether or not a predetermined object is included in the captured image (step S312). CPU 110 may determine whether or not the worker, robot 600, workpiece, etc. are in a predetermined state (step S312).

When a predetermined object is included in the captured image, or when the CPU 110 recognizes a predetermined state (YES in step S312), CPU 110 transmits an instruction to shift to the check mode to wearable terminal 300 via communication interface 160 (step S322). CPU 310 of wearable terminal 300 receives this command, sets a higher resolution of image data captured by camera 350, sets a higher frame rate for image data captured by the camera 350, starts communication with the control device 100, and sets a higher frequency of communication with the control device 100.

When the captured image does not include the predetermined object, or when the CPU 110 does not recognize a predetermined state (YES in step S312), CPU 110 starts a timer or continues the timer counting (step S314). When the timer reaches the predetermined time without reaching the predetermined state (YES in step S316), CPU 110 transmits a command to shift to the power saving mode to wearable terminal 300 via communication interface 160 (step S330). CPU 310 of wearable terminal 300 receives this command, sets a lower resolution of image data captured by camera 350, sets a lower frame rate for image data captured by the camera 350, stops communication with the control device 100, and sets a lower frequency of communication with the control device 100. When the timer does not reach the predetermined time (NO in step S316), CPU 110 repeats the process from step S302.

### Review

The foregoing embodiments provide a wearable terminal that includes a camera, a wireless communication antenna, a memory and a processor for changing the capture mode of the camera or communication mode of the wireless communication antenna when a predetermined condition is satisfied.

Preferably, the processor determines that the predetermined condition is satisfied when a predetermined object or a predetermined situation is recognized based on the image captured by the camera.

Preferably, the wearable terminal further includes an acceleration sensor. The processor determines that the predetermined condition is satisfied when the measured value of the acceleration sensor reaches a predetermined value.

Preferably, the wearable terminal further includes a position acquisition antenna. The processor determines that the predetermined condition is satisfied when the processor recognizes that the wearable terminal is at a predetermined position based on the measurement value of the position acquisition antenna.

Preferably, the processor changes the size of the image captured by the camera as the change of the capture mode.

Preferably, the processor changes the frame rate of capturing images by the camera as the change of the capture mode.

Preferably, the processor starts and ends uploading of the image captured by the camera using the wireless communication antenna as the change of the communication mode.

The embodiments disclosed herein are to be considered in all aspects only as illustrative and not restrictive. The scope of the present invention is to be determined by the scope of the appended claims, not by the foregoing descriptions, and the invention is intended to cover all modifications falling within the equivalent meaning and scope of the claims set forth below.

What is claimed is:

1. A wearable terminal comprising:
a camera;
a wireless communication antenna;
a memory; and
a processor for changing the capture mode of the camera or communication mode of the wireless communication antenna when a predetermined condition is satisfied.

2. The wearable terminal according to claim 1, wherein
the processor determines that the predetermined condition is satisfied when a predetermined object or a predetermined situation is recognized based on the image captured by the camera.

3. The wearable terminal to claim 1, further comprising an acceleration sensor, wherein
the processor determines that the predetermined condition is satisfied when the measured value of the acceleration sensor reaches a predetermined value.

4. The wearable terminal to claim 1, further comprising a position acquisition antenna, wherein
the processor determines that the predetermined condition is satisfied when the processor recognizes that the wearable terminal is at a predetermined position based on the measurement value of the position acquisition antenna.

5. The wearable terminal according to claim 1, wherein
the processor changes the size of the image captured by the camera as the change of the capture mode.

6. The wearable terminal according to claim 1, wherein
the processor changes the frame rate of capturing images by the camera as the change of the capture mode.

7. The wearable terminal according to claim 1, wherein
the processor starts and ends uploading of the image captured by the camera using the wireless communication antenna as the change of the communication mode.
